(19) United States
(12) Patent Application Publication
(10) Pub. No.: US 2008/0170528 A1
(43) Pub. Date: Jul. 17, 2008

(54) METHOD OF MULTICASTING BASE AND ENHANCEMENT LAYERS OF A VIDEO STREAM

(76) Inventors: Peter Bosch, New Providence, NJ (US); Katherine H. Guo, Scotch Plains, NJ (US); John P. Hearn, New Providence, NJ (US); Girija J. Narlikar, Basking Ridge, NJ (US)

Correspondence Address: MARK W. SINCELL;Williams, Morgan & Amerson, P.C., Suite 1100, 10333 Richmond, Houston, TX, 77042, US

(21) Appl. No.: 11/622,866

(22) Filed: Jan. 12, 2007

(51) Int. Cl. H04H 20/71; H04J 15/00

(52) U.S. Cl. 370/312; 370/328

(57) ABSTRACT

The present invention provides a method of multicasting video streams. The method includes accessing, at a base station, a first packet from a video stream that includes a plurality of packets. Each packet in the video stream is assigned to either a base layer or at least one enhancement layer. The method also includes encoding the first packet using a coding scheme selected based on whether the first packet is assigned to the base layer or an enhancement layer.

### BACKGROUND OF THE INVENTION

1. Field of the Invention

This invention relates generally to communication systems, and, more particularly, to wireless communication systems.

2. Description of the Related Art

Conventional wireless communication systems typically include one or more devices that provide wireless connectivity over an air interface. Depending upon the type of wireless access technology implemented in the wireless communication system, the devices may include base stations, base station routers, access points, and the like. For example, in a cellular telephone system such as a Universal Mobile Telecommunication System (UMTS) or a Global System for Mobile communication (GSM), base stations may be used to provide wireless connectivity within associated geographic areas or cells. For another example, in a WiFi system or a short-range wireless communication system implemented in accordance with Bluetooth or one of the IEEE standards, an access point may be used to provide wireless connectivity within a hotspot, such as an airport terminal or a coffee shop.

Mobile units may communicate with the base stations over the air interface. Exemplary mobile units may include cellular telephones, personal data assistants, smart phones, paging devices, text messaging devices, global positioning system (GPS) devices, network interface cards, notebook computers, desktop computers, and the like. For example, mobile units may transmit and/or receive messages including voice and/or data information, signaling information, paging messages, broadcast messages, and the like. The base stations are typically communicatively coupled to one or more networks so that the mobile units may communicate with other devices that are also communicatively coupled to the networks. For example, one mobile unit may establish a wireless communication link with another mobile unit via a network coupled to the associated base stations. For another example, mobile units may receive information from a server attached to the network.

Servers attached to the network may transmit information to mobile units using either point-to-point communication techniques or point-to-multipoint communication techniques, which conventionally include multicast and/or broadcast techniques. In point-to-point communication, e.g., from the server to a specific mobile unit, transmitted packets include a packet header that includes information indicative of the mobile unit, such as a media access control (MAC) layer address. The packet may then be transmitted to a base station associated with the mobile unit and the base station may transmit the packet over the air interface. Each packet may be divided up into a number of messages for transmission over the air interface. Each message includes the relevant mobile unit address and a portion of the payload of the original packet. Since the air interface is a shared medium that may carry packets or messages destined for many different mobile units, each mobile unit only “listens” to packets or messages that include the mobile unit's address.

Point-to-multipoint communication permits a server to transmit the same information to more than one mobile unit. For example, users of mobile units may be subscribed to receive a multicast or broadcast service such as a pay-per-view television program provided by a server. The mobile units that are subscribed to the multicast or broadcast service are typically referred to as receivers of the service. The subscribed mobile units may be assigned a multicast or broadcast address for the point-to-multipoint transmission. The server then transmits information to the broadcast/multicast address and the subscribed mobile units “listen” for transmission associated with this address. Thus, the server may multicast the pay-per-view television program to all of the receivers by multicasting or broadcasting a stream of packets representative of the pay-per-view television program to the receivers using the multicast/broadcast address.

Video streams that are intended to be broadcast to one or more receivers may be divided up into multiple layers, such as a base layer and one or more enhancement layers. The base layer may include a subset of the packets in the video stream and the remaining packets may be included in one or more of the enhancement layers. Some broadcast wireless networks, such as QUALCOMM's MediaFlo™ system, are capable of transmitting data at multiple rates so that the base layer packets may be encoded and transmitted at a relatively low rate while the enhancement layer packets are encoded and transmitted at a relatively high rate. If the channel quality of a wireless communication link between a receiver and a transmitting base station is relatively low, then the receiver may only be able to decode the relatively low rate base layer packets, which may result in the receiver producing a relatively low quality video. If the channel quality of the wireless communication link is relatively high, then the receiver may be able to decode both the base layer packets and the relatively high rate enhancement layer packets, which may result in the receiver producing a relatively high quality video. However, the receivers in a broadcast wireless network do not provide any feedback that may be used to schedule either the base or enhancement layer packets.

Video streams may also be multicast to one or more receivers. For example, the High Speed Downlink Packet Access (HSDPA) system, which is part of the Third Generation Partnership Project (3GPP) standards and/or protocols, could be extended with a multicast scheduler to schedule a single stream of data across multiple receivers in a time-division manner every transmission time interval (TTI). For example, base stations or base station routers may include a multicast scheduler that may schedule multicasting of a single video stream to the receivers in the system. The receivers may provide feedback, such as an acknowledgment (ACK) message indicating that a packet has been successfully received and/or a negative acknowledgment (NAK) message indicating that the packet was not successfully received. The receivers may also provide information indicating current channel conditions. The multicast scheduler in the base station or base station router may then use the feedback to select a coding rate for the next packet in the data stream. The multicast scheduler may also determine whether to reschedule data that has not been successfully decoded by all the receivers. However, conventional base stations and/or base station routers are not able to parse video packets provided by a server and therefore function as passive transmitters of the video data stream.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, methods are provided for multicasting video streams. One embodiment of the method includes accessing, at a base station, a first packet from a video stream that includes a plurality of packets. Each packet in the video stream is assigned to either a base layer or at least one enhancement layer. The method also includes encoding the first packet using a coding scheme selected based on whether the first packet is assigned to the base layer or an enhancement layer. Another embodiment of the method includes receiving, over an air interface, a first packet from a video stream comprising a plurality of packets. Each packet in the video steam is assigned to either a base layer or at least one enhancement layer. The first packet is encoded using a coding scheme selected based on whether the first packet is assigned to the base layer or at least one enhancement layer.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates one exemplary embodiment of a wireless communication system, in accordance with the present invention;

FIG. 2 conceptually illustrates one exemplary embodiment of a video data stream, in accordance with the present invention;

FIG. 3 conceptually illustrates one exemplary embodiment of a method of transmitting a video data stream over an air interface, in accordance with the present invention; and

FIG. 4 conceptually illustrates one exemplary embodiment of a method for receiving a video data stream that has been transmitted over an air interface, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

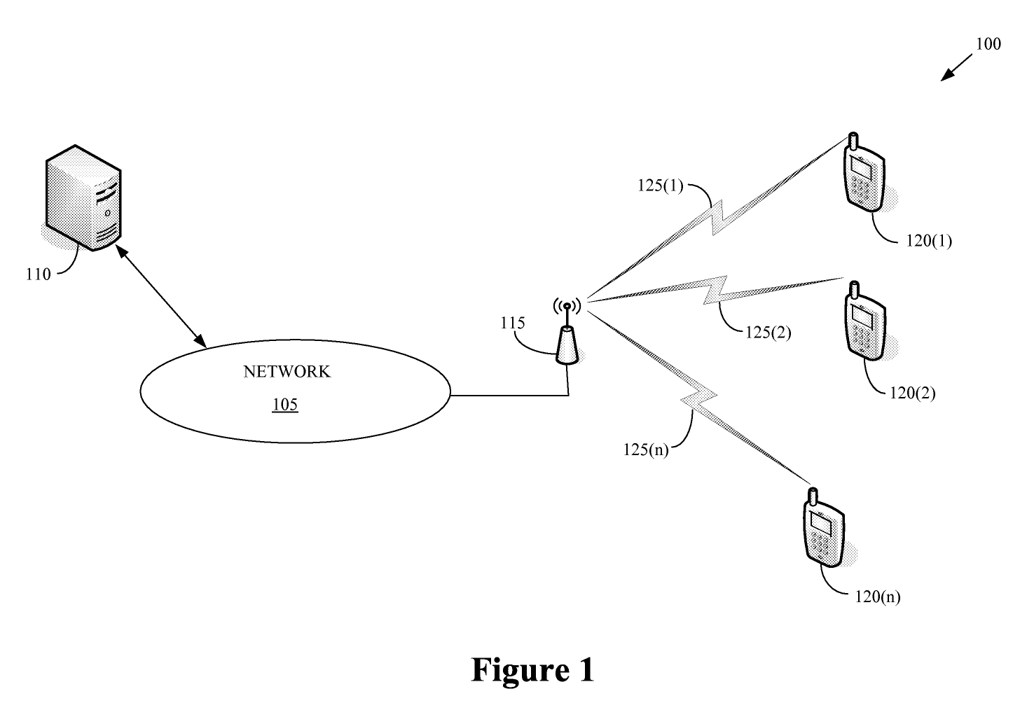

FIG. 1 conceptually illustrates one exemplary embodiment of a wireless communication system 100. In the illustrated embodiment, the wireless communication system 100 includes a network 105 that operate according to one or more standards and/or protocols defined by the Third Generation Partnership Project (3GPP, 3GPP2). Accordingly, the network 105 may implement High Speed Downlink Packet Access (HSDPA) for transmitting data packets. Techniques for implementing HSDPA in the wireless communication system 100 are known in the art and in the interest of clarity only those aspects of HSDPA that are relevant to the present invention will be discussed further herein. Moreover, persons of ordinary skill in the art having benefit of the present disclosure should appreciate that the present invention is not limited to a network 105 that implements HSDPA according to the 3GPP standards and/or protocols. In alternative embodiments, the network 105 may implement other standards and/or protocols that may be used to transmit data packets.

The network 105 is communicatively coupled to a media server 110 that is configured to provide point-to-multipoint media services, such as multicasting one or more video data streams. Although the media server 110 is depicted as a single entity in FIG. 1, persons of ordinary skill in the art having benefit of the present disclosure should appreciate that the media server 110 may be implemented in any number of distinct and separate entities. For example, the media server 110 may include one entity for generating the video data stream and a second entity for multicasting the video data stream over the network 105. One or more base stations 115 are also communicatively coupled to the network 105 and may be configured to transmit the multicast media over an air interface. Persons of ordinary skill in the art having benefit of the present disclosure should appreciate that the term “base station” will be used herein to refer to any device for providing wireless connectivity including, but not limited to, base stations, base station routers, access points, and the like. The base stations 115 may operate according to 3GPP standards and/or protocols, as well as other wireless communication standards and/or protocols.

The wireless communication system 100 also includes one or more mobile units 120(1-n). The distinguishing indices (1-n) may be used to indicate particular mobile units 120(1-n) or subsets thereof. However, the distinguishing indices (1-n) may be dropped when referring to the mobile units 120 collectively. This convention may also be applied to other elements shown in the drawings and indicated by a numeral and one or more distinguishing indices. The mobile units 120 may access the network 105 via wireless communication links 125 with the base station 115. In the illustrated embodiment, the wireless communication links 125 include uplink and downlink signaling and/or traffic channels that may be used to support the multicasting of one or more media streams. For example, the wireless communication links 125 may include the uplink and downlink signaling and/or traffic channels used to implement HSDPA according to the 3GPP standards and/or protocols.

In the illustrated embodiment, the mobile units 120 are subscribed to receive a multicast service, such as a video streaming service, from the media server 110. For example, the mobile units 120 may be subscribed to receive a multicast pay-per-view television event. The media server 110 may therefore create a video data stream and provide the video data stream to the base station 115 via the network 105 for transmission to the mobile units 120 over a wireless communication link 125. The video data stream includes packets that contain information that may be used by the mobile units 120 to reconstruct and/or play the streaming video, e.g., the multicast pay-per-view television event.

The packets in the video stream may be divided into a plurality of layers, such as a base layer and one or more enhancement layers. As used herein, the term “base layer” may refer to packets or frames that may be used to construct and/or play a portion of the video without reference to other packets or frames in the video stream. However, persons of ordinary skill in the art should appreciate that the base layer is not limited to independent frames and in some embodiments the base layer may also include combinations of independent and dependent packets or frames. The term “enhancement layer” will refer to packets or frames that may be used to construct and/or play a portion of video when combined with (or referenced to) information included in one or more base layer packets or frames. For example, a video frame that is encoded according to the MPEG-4 standard may include I-frames and P-frames. An I-frame is a video frame that has been encoded without reference to any other frame of video and is therefore a base layer frame. A video stream or recording may start with an I-frame and typically contains regular I-frames throughout the stream. The I-frames may also be called intra frames, key frames, or access points. The P-frames are motion-compensated frames that make use of the difference between the current frame being encoded and a previous frame of video to ensure that information that does not change, e.g. a static background, is not repeatedly transmitted. In some embodiments, the video stream may also include other enhancement layer frames, such as bilinear B-frames.

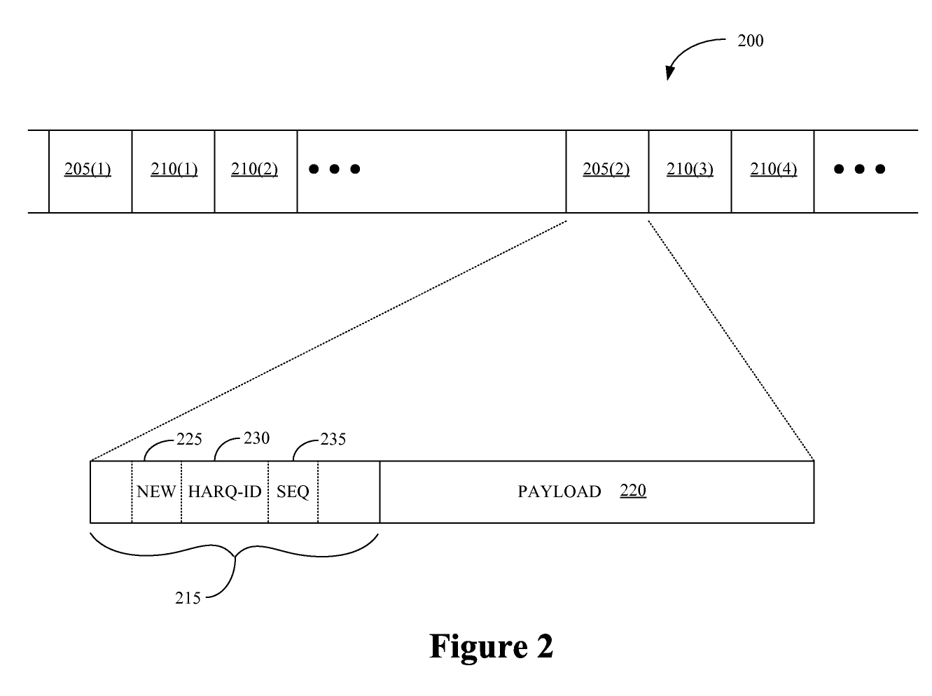

FIG. 2 conceptually illustrates one exemplary embodiment of a video data stream 200. In the illustrated embodiment, the video data stream 200 includes one or more base layer packets 205 and one or more enhancement layer packets 210. The enhancement layer packets 210 may all be associated with the same enhancement layer or they may be associated with different enhancement layers. For example, the enhancement layer packets 210(1, 3) may be associated with a first enhancement layer, such as a P-frame layer, and the enhancement layer packets 210(2, 4) may be associated with a second enhancement layer, such as a B-frame layer. The packets 205, 210 may include new information or they may be retransmissions of previously transmitted packets. For example, the packet 205(2) may be a retransmission of the packet 205(1) that was retransmitted according to a hybrid automatic repeat request (HARQ) protocol.

The packets 205, 210 include a header 215 and a payload 220. The payload 220 typically includes information that is used to reconstruct and/or play back the video stream and the header 215 typically includes information that is used for operations such as decoding the packets 205, 210, combining retransmissions of packets, 205, 210, ordering the packets 205, 210, and the like. In the illustrated embodiment, the header 215 includes a field 225 that indicates whether the information included in the payload 220 is new information or is a retransmission of a previously transmitted payload 220. The header 215 also includes a field 230 that includes an identifier that may be used to associate the information in the payload 220 with previously transmitted payloads (in the case the present payload 220 is a retransmission) or future payloads (in the case that the present payload 220 is not successfully decoded). On example of such an identifier is a HARQ-ID. The header 215 further includes a field 235 that includes a sequence number that may be used to order the decoded payloads 220 so that the video stream is correctly reconstructed and/or played back. However, persons of ordinary skill in the art having benefit of the present disclosure should appreciate that the header 215 may include other information not described herein.

Referring back to FIG. 1, the base station 115 is capable of determining whether video data stream packets provided by the media server 110 are part of a base layer or are part of one or more enhancement layers. In one embodiment, the video data stream is encoded at a single rate and the base layer consists of the I-frames in the video data stream. The enhancement layer may consist of all the remaining frames, such as P-frames and B-frames. Depending on the codec used by the media server 110, the base station 115 may then determine the packet layer by accessing one or more fields within the packet. For example, packets that are encoded according to the real-time transport protocol (RTP) payload format for MPEG-4 (which is defined in the Request for Comment 3640) include a random access point (RAP) flag field that indicates whether or not the packet is a random access point. If this field indicates that the packet is a random access point, this implies that the packet belongs to an I-frame and is therefore a base layer packet. If this field indicates that the packet is not a random access point, then the packet is part of a frame that is included in the enhancement layer. For another example, packets that are encoded according to the RTP payload format for H.264 (which is defined in the Request for Comment 3984) include a NRI field. The parameter NRI stands for nal_ref_idc and “nal” stands for network abstraction layer. The highest value of NRI indicates that the packet is a base layer packet. For example, the NRI typically includes 2 bits. A value of 00 for the NRI bits indicates that the content of the NAL structure is not used to reconstruct reference pictures for inter-picture prediction and therefore can be discarded without risking the integrity of the reference pictures. Values of the NRI that are greater than 00 indicate that decoding of the NAL unit is required to maintain the integrity of the reference pictures. For yet another example, in H.264 with multi-rate coding, the NRI field may specify the layer of the packet. In one embodiment, the base station 115 may also be able to extract a time stamp from the packet header. For example, the base station may extract an RTP timestamp from an RTP header.

The base station 115 may then encode packets from the video data stream based upon the layer associated with the packet. In one embodiment, the base station 115 may select a relatively conservative coding scheme for the base layer packets to improve the likelihood that the base layer packets are successfully decoded by the mobile units 120. The base station 115 may select a relatively aggressive coding scheme for the enhancement layer packets. Accordingly, the base layer packets may be successfully decoded by a relatively large percentage of the mobile units 120, while the enhancement layer packets may only be decoded by mobile units 120 having relatively good channel conditions. The specific coding schemes employed and the criteria for associating the coding schemes with different channel conditions are matters of design choice. Furthermore, the base station 115 may implement a retransmission scheme, such as HARQ, and so may attempt to retransmit packets that have not been positively acknowledged by all of the mobile units 120. In one embodiment, the number of retransmissions of a packet may be limited based upon the layer associated with the packet. For example, a relatively large number of retransmission attempts may be permitted for base layer packets and a relatively small number of retransmission attempts may be permitted for enhancement layer packets. In various alternative embodiments, the coding schemes, the association of these coding schemes with different channel conditions, and/or the maximum number of retransmissions may be pre-selected and/or dynamically determined. The base station 115 may also use the timestamp in the video packet headers to detect when it is too late to retransmit a packet.

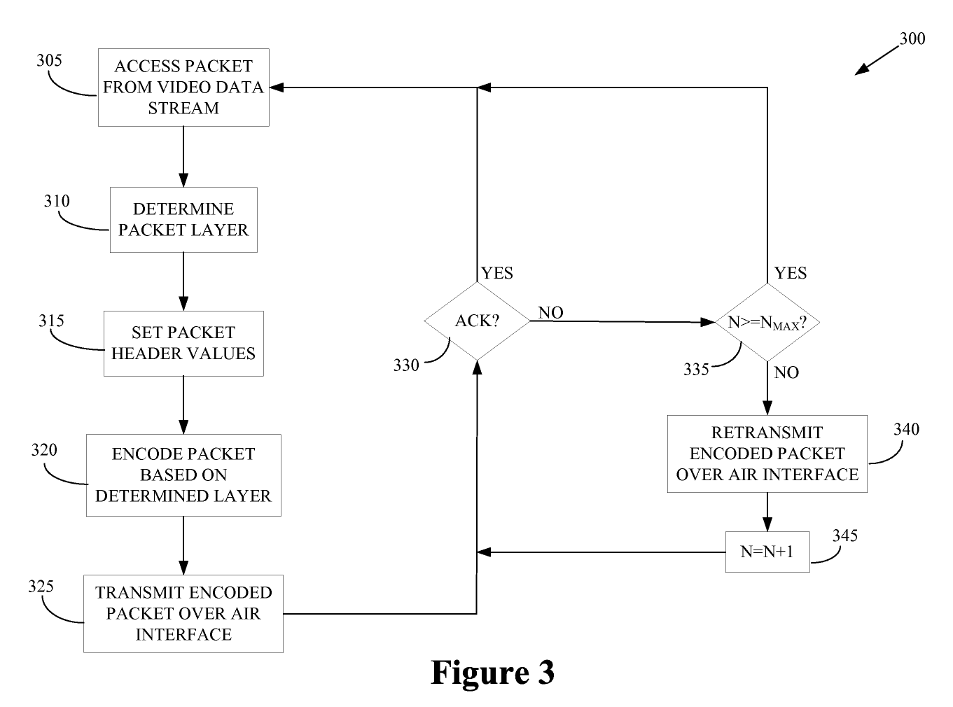

FIG. 3 conceptually illustrates one exemplary embodiment of a method 300 of transmitting a video data stream over an air interface. In the illustrated embodiment, the base station may access (at 305) a packet from a video data stream, which may be provided by a media server over a network. The base station determines (at 310) the packet layer. For example, the base station may use one or more flags in the packet header to determine (at 310) whether the packet is a base layer packet or an enhancement layer packet. The base station may then set (at 315) one or more values, flags, or fields in the packet header. In one embodiment, the base station may set (at 315) values of a new information field, a HARQ-ID field, and a sequence number field. For example, in the HSDPA standard, the base station may toggle (at 315) a new data indicator to indicate that the packet is a new packet, as well as setting (at 315) the value of the HARQ-ID of the current packet. The base station may also set (at 315) the sequence number of the current packet, which allows the packet to be distinguished from neighboring packets and allows the received packets to be assembled in order.

The packet may then be encoded (at 320) based upon the packet layer. For example, base layer packets may be encoded (at 320) at a relatively low data rate (e.g., a conservative coding scheme) and enhancement layer packets may be encoded (at 320) at a relatively high data rate (e.g., an aggressive coding scheme). The encoded packet may then be transmitted (at 325) over an air interface towards one or more mobile units that have subscribed to the service associated with the video data stream. For example, the base station may transmit (at 325) the new data indicator, the HARQ-ID, the sequence number, the payload, and any other information over one or more signaling and/or data channels supported by the air interface. After the packet has been transmitted (at 325) the base station may listen for acknowledgments and/or negative acknowledgments from the subscribed mobile units.

If the base station receives (at 330) a positive acknowledgment indicating that the transmitted packet has been successfully received and/or decoded by all (or a selected threshold percentage of) the mobile units, then the station may access (at 305) another packet from the video data stream for transmission (at 325) to the mobile units. However, if the base station receives (at 330) a negative acknowledgment or other indication that the transmitted packet was not successfully received and/or decoded by all (or a selected threshold percentage of) the mobile units, and the base station may determine whether or not to retransmit the encoded packet. In the illustrated embodiment, this determination begins with determining (at 335) whether or not the number (N) of previous retransmissions of the encoded packet exceeds a maximum number (N_{MAX}) of permitted retransmissions. As discussed herein, the number of permitted retransmissions may be determined based upon the packet layer. If the number of previous retransmissions of the encoded packet is less than the number of permitted retransmissions, and the encoded packet may be retransmitted (at 340) and the number of previous retransmissions may be incremented (at 345).

The base station can provide an indication that the encoded packet will not be retransmitted when the number of previous retransmissions is greater than or equal to the number of permitted transmissions. Thus, if the base station determines (at 335) that the number of previous retransmissions is greater than or equal to the number of permitted transmissions, then the base station may access (at 305) a new packet from the video data stream and determine (at 310) the packet layer associated with the new packet. The base station may then set (at 315) the packet header values for the new packet. Since the previous packet is not going to be retransmitted, the base station may set (at 315) the new data indicator to a value that indicates that the packet contains new information and may set (at 315) the HARQ-ID to the value of the HARQ-ID associated with the previous packet, i.e., the packet that is not going to be retransmitted. The mobile units may then use this information to determine that the packet associated with the HARQ-ID is not going to be retransmitted and so the HARQ buffer associated with the previous packet may be cleared, as will be discussed in detail below.

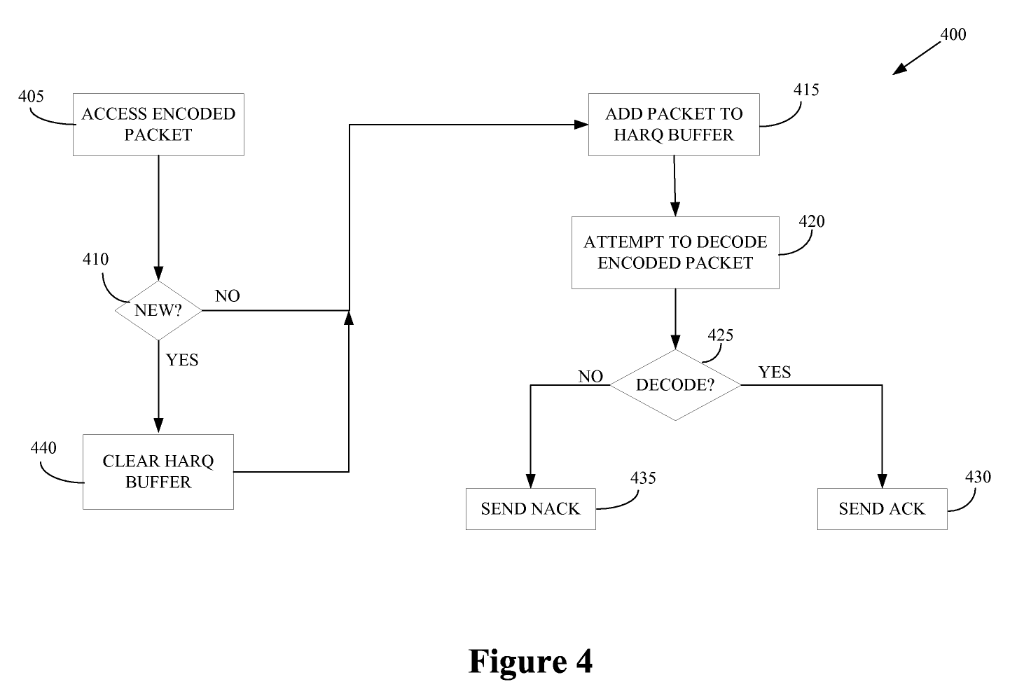

FIG. 4 conceptually illustrates one exemplary embodiment of a method 400 for receiving a video data stream that has been transmitted over an air interface. In the illustrated embodiment, the mobile unit accesses (at 405) the packet that is part of a video data stream, such as a packet that has been transmitted by a base station over an air interface. The mobile unit then determines (at 410) whether the packet includes new information or is a retransmission of a previously transmitted packet, e.g., by inspecting the new information field associated with the packet. If the mobile unit determines (at 410) that the encoded packet is not a new packet and this is a retransmission, then the mobile unit may add (at 415) the packet to a buffer and attempt to decode (at 420) the retransmitted packet using the contents of the buffer. For example, the mobile unit may combine (at 415) the newly received encoded packet with previously transmitted information stored in a buffer indicated by the HARQ-ID in the newly received packet and then attempt to decode (at 420) the combined information. If the mobile unit successfully decodes (at 425) the newly received packet, then the mobile unit may send (at 430) an acknowledgement back to the base station indicating that the packet has been successfully decoded. However, if the mobile unit does not successfully decode (at 425) into the received packet, then the mobile unit may send (at 435) a negative acknowledgment indicating that the packet was not successfully decoded and requesting retransmission of the packet.

Returning to step 410, if the mobile unit determines (at 410) that the encoded packet is a new packet, e.g., by inspecting the new information field associated with the packet, then the mobile unit may clear (at 440) the HARQ buffer indicated by a HARQ-ID included in a HARQ-ID field in the header of the packet. Persons of ordinary skill in the art having benefit of the present disclosure should appreciate that the mobile unit may also take other actions in addition to clearing (at 440) the HARQ buffer when the mobile unit determines (at 410) that the encoded packet is a new packet. For example, an unacknowledged mode may be used at the radio link control (RLC) layer to ensure that no additional retransmissions are made at the RLC layer and that any missing packets are handled appropriately at the application layer by the video data stream decoder. The mobile unit may then add (at 415) the new packet to the buffer indicated by the HARQ-ID and proceed with attempting (at 420) to decode the encoded packet using the contents of the buffer.

As the packets are received and decoded, the mobile unit may use these packets to construct and/or play back portions of the video. In one embodiment, the mobile unit first attempts to re-order the received packets according to their sequence numbers. If the base station has elected to stop transmitting one or more packets and proceed to the next packet, some mobile units that were not able to decode the transmission may not be able to deliver subsequently received packets to higher layers. Thus, to avoid blocking of subsequent packets caused by missing sequence numbers, a blocking timer in the media access control layer may be set to a sufficiently low value that continuity of the stream is not jeopardized by the re-ordering function.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the invention. Accordingly, the protection sought herein is as set forth in the claims below.

What is claimed:

1. A method, comprising:
accessing, at a base station, a first packet from a video stream comprising a plurality of packets, each packet being assigned to either a base layer or at least one enhancement layer; and
encoding the first packet using a coding scheme selected based on whether the first packet is assigned to the base layer or said at least one enhancement layer.

2. The method of claim 1, comprising determining whether the first packet is assigned to the base layer or said at least one enhancement layer.

3. The method of claim 2, wherein determining whether the first packet is assigned to the base layer or said at least one enhancement layer comprises determining whether the first packet is assigned to the base layer or said at least one enhancement layer based on at least one of a random access point field in the first packet and a NRI field in the first packet.

4. The method of claim 1, wherein encoding the first packet comprises encoding the first packet using a relatively conservative coding scheme when the first packet is determined to be assigned to the base layer and encoding the first packet using a relatively aggressive coding scheme when the first packet is determined to be assigned to at least one enhancement layer.

5. The method of claim 1, comprising providing the first packet encoded according to the selected coding scheme over an air interface.

6. The method of claim 5, wherein providing the first packet over the air interface comprises providing at least one of information indicating whether the first packet is a new or retransmitted packet, information indicating a retransmission identifier associated with the first packet, and information indicating a sequence number of the first packet.

7. The method of claim 6, comprising determining a maximum number of retransmissions of the first packet based on whether the first packet is assigned to the base layer or said at least one enhancement layer.

8. The method of claim 7, comprising selecting a predetermined coding scheme or selecting the coding scheme dynamically, and wherein determining the maximum number of retransmissions of the first packet comprises determining the maximum number of retransmissions of the first packet dynamically or using a predetermined maximum number of retransmissions of the first packet.

9. The method of claim 8, comprising receiving at least one of an acknowledgment and a negative acknowledgment in response to providing the first packet over the air interface.

10. The method of claim 9, comprising retransmitting the first packet in response to receiving at least one negative acknowledgment if the number of prior retransmissions of the first packet is less than the maximum number of retransmissions.

11. The method of claim 9, comprising transmitting a second packet in response to receiving at least one negative acknowledgment if the number of prior retransmissions of the first packet is greater than or equal to the maximum number of retransmissions.

12. The method of claim 11, wherein transmitting the second packet comprises transmitting information indicating that the second packet is new and information indicative of a retransmission identifier associated with the first packet.

13. A method, comprising:
receiving, over an air interface, a first packet from a video stream comprising a plurality of packets, each packet being assigned to either a base layer or at least one enhancement layer, the first packet being encoded using a coding scheme selected based on whether the first packet is assigned to the base layer or at least one enhancement layer.

14. The method of claim 13, wherein receiving the first packet comprises receiving a first packet that is part of an I-frame, a P-frame, or a B-frame.

15. The method of claim 13, wherein receiving the first packet comprises receiving the first packet encoded using a relatively conservative coding scheme when the first packet is determined to be assigned to the base layer and receiving the first packet encoded using a relatively aggressive coding scheme when the first packet is determined to be assigned to at least one enhancement layer.

16. The method of claim 13, comprising attempting to decode the first packet according to the coding scheme.

17. The method of claim 16, comprising providing an acknowledgment in response to successfully decoding the first packet and a negative acknowledgment in response to unsuccessfully decoding the first packet.

18. The method of claim 17, comprising receiving at least one retransmission of the first packet in response to providing the negative acknowledgment.

19. The method of claim 18, comprising receiving a second packet in response to providing the negative acknowledgment.

20. The method of claim 19, comprising clearing information associated with the first packet if the second packet comprises information indicating that the second packet is new and information indicative of a retransmission identifier associated with the first packet.
